(19) United States
(12) Patent Application Publication
(10) Pub. No.: US 2009/0040957 A1
(43) Pub. Date: Feb. 12, 2009

(54) Prepositioning Data For Wireless Applications

(76) Inventor: Thomas Anschutz, Conyers, GA (US)

Correspondence Address: AT&T Legal Department;Attn: Patent Docketing, Room 2A-207, One AT&T Way, Bedminster, NJ, 07921, US

(21) Appl. No.: 11/836,815

(22) Filed: Aug. 10, 2007

(51) Int. Cl. H04H 1/00

(52) U.S. Cl. 370/312

(57) ABSTRACT

Provided are methods, systems and devices for pre-positioning data objects on a group or sub-group of mobile communication device which comprises receiving a datagram containing a data object and a multicast address via a multicast by a network node within a mobile communications network and satisfying at least one of a set of logic rules concerning the delivery of the datagram to the group of mobile communication devices by the network node based at least on the multicast address. A determination is made by the network node if a last hop node within the mobile communications network has an active MCD within broadcast range. If the last hop node has an active MCD within broadcast range, then multicasting the datagram to the last hop node for physical broadcast.

### TECHNICAL FIELD

The subject matter described herein relates to the field of radio communications. More particularly it relates to devices and methods using multicasting technology to preposition data within a communications network.

### BACKGROUND

The ownership and use of mobile communications devices has become ubiquitous over the last decade. With the increasing popularity has come an ever increasing demand for more sophisticated applications and services to be provided through this communication channel which has contributed to an ever increasing demand for bandwidth. Of particular consumer interest is the ability to access graphical and other large data files that have particularly large bandwidth requirements on a real time or near real time basis.

Bandwidth capacity within a mobile communications network is limited due to finite physical infrastructure which is costly to expand and to integrate. However, user demand for communication of large graphical or other data files absolutely uses large amounts available bandwidth which is scarce particularly during peak usage periods. As such, a need exits to more efficiently utilize the existing bandwidth capacity of current mobile communications networks while simultaneously delivering enhanced services.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Provided are exemplary embodiments. The embodiments include a network computing device in communication with a mobile communication device (“MCD”) that includes a network interface, the network interface allowing the network computing device to receive a data object sent by a data source destined for a multicast address, a multicast mapping module, the multicast mapping module mapping the multicast address to one or more MCD unicast addresses which have been joined to the multicast address and a processor for receiving the data object and pre-positioning the data object within the MCD by multicasting the data object to the one or more MCD unicast addresses prior to the data object being required from the network computing device by the MCD.

Exemplary embodiments also include a method for pre-positioning a data object within a mobile communication device (“MCD”) including receiving a datagram containing a data object and a multicast address via a multicast by a network node within a mobile communications network prior to the MCD requesting he data object and determining by the network node if a last hop node within the mobile communications network has an active MCD within broadcast range. If the last hop node has an active MCD within broadcast range, then multicasting the datagram to the last hop node for physical broadcast. If the last hop node does not have an active MCD within broadcast range, then instructing the last hop node not to physically broadcast the datagram.

In accordance with other exemplary embodiments, a computer readable medium containing a program within a logic device executing instructions to pre-positioning a data object within a mobile communication device (“MCD”) including instructions to receive a datagram containing a data object and a multicast address via a multicast by a network node within a mobile communications network prior to the MCD requesting the data object and determine by the network node if a last hop node within the mobile communications network has an active MCD within broadcast range. If the last hop node has an active MCD within broadcast range, then multicast the datagram to the last hop node for physical broadcast. If the last hop node does not have an active MCD within broadcast range, then instruct the last hop node not to physically broadcast the datagram.

Other apparatuses, methods, and/or systems according to embodiments will be or become apparent to one with skill in the art upon review of the following drawings and Detailed Description. It is intended that all such additional apparatus, systems and/or methods be included within this description, be within the scope of the present invention, and be protected by the accompanying claims.

### BRIEF DESCRIPTION OF THE DRAWINGS

FIG. 1 is an abstract depiction of a mobile communication network according to embodiments described herein.

FIG. 2 is an abstract depiction of a MCD according to embodiments described herein.

FIG. 3 is a simplified functional diagram of a mobile communication network server device according to embodiments described herein.

FIG. 4 is a simplified flow diagram of a method for pre-positioning a data object within a MCD according to embodiments described herein.

FIG. 5 is a simplified flow diagram depicting the pre-positioning of a data object by a network server according to embodiments described herein.

### DETAILED DESCRIPTION

The following disclosure is directed to software, methods and devices that deliver data or data objects to a mobile communication devices (“MCD”) while conserving available mobile communication network bandwidth. The subject matter now will be described more fully below with reference to the attached drawings which are illustrative of various embodiments herein. Like numbers refer to like objects throughout the following disclosure. The attached drawings have been simplified to clarify the understanding of the systems, devices and methods disclosed. The subject matter may be embodied in a variety of forms and the exemplary configurations and descriptions, infra, are provided to more fully convey the scope of the disclosure.

Data transmission to multiple MCDs in the prior art relies primarily on redundant point-to-point unicast transmission to each communication device. Such a unicast transmission is used in providing RSS web feeds, for example. However, repeated unicasts to thousands of users seeking the same information results is wasted bandwidth and may place a strain on current network infrastructure particularly during hours of peak usage. According to various embodiments herein, bandwidth limitations within mobile communication networks when unicasting data objects repeatedly to many different MCDs may be alleviated by what may be described as dynamic multicasting. As non-limiting examples, such mobile communications devices as discussed herein may include cell phones, pagers, personal communication devices, MP3 players, IP Television receivers, laptop computers, palm computers and the like. Such multicasting may also be useful with desktop computing devices as well.

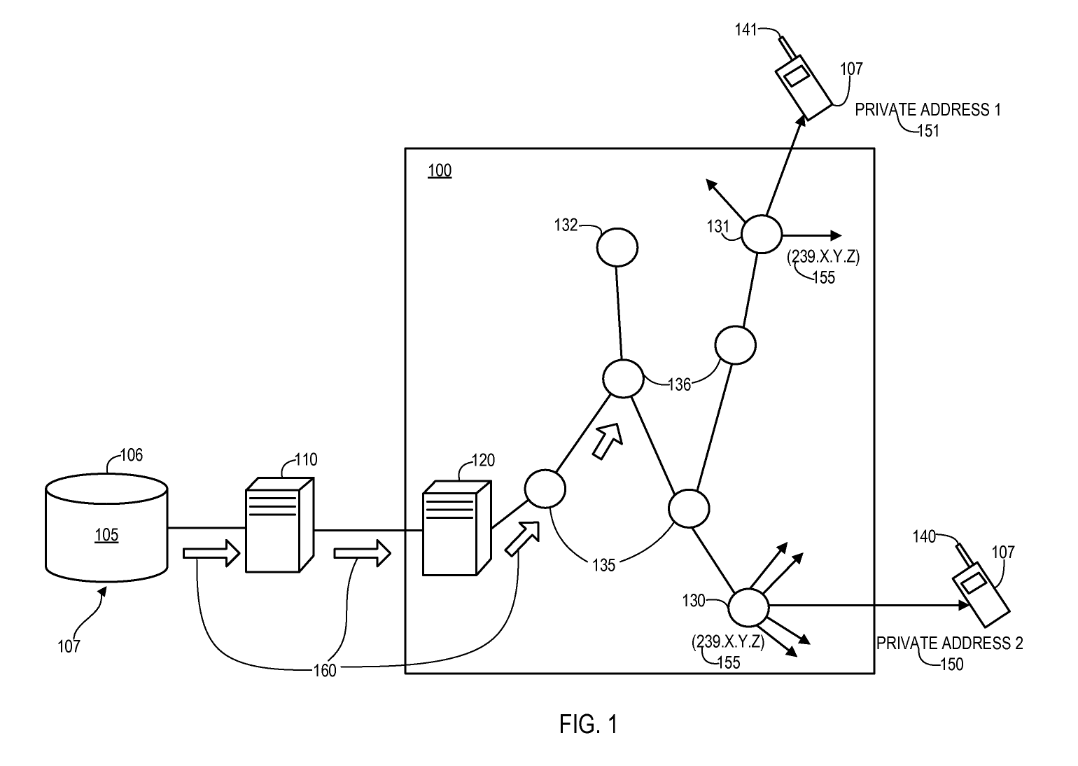

FIG. 1 illustrates an exemplary mobile communications network. A typical mobile communication network comprises thousands of components providing wireless communication services to thousands of MCDs. An IP network 100 depicted in FIG. 1 has been simplified for clarity of explanation. Typical mobile communications, such as cell phone voice communications, transmit a telephone call from the service provider to a single MCD using a technique referred to as unicasting. Unicasting is conceptually simple and technologically straight forward and may be analogous to a single telephone call being routed from a caller to a called party over a dedicated circuit in a conventional circuit switched telephone network. Unicasting has advantages in being targeted to a single user of a MCD 140 with a single unique IP address 150/151. A unicast message may be encrypted for security at the physical transport layer as well as other layers such as the application layer. However, communicating the same data to multiple users in a unicast mode is unnecessarily redundant.

On the other end of the technology spectrum one may use a pure broadcast technique where a message containing a data object 160 is transmitted to all MCDs 140/141 within range of a last hop node (e.g. transmitter) 130-132. All of the MCDs 140/141 within transmission range may physically receive the broadcast transmission regardless of whether the MCDs have a unique address or not. Broadcasting has the advantage of requiring only a single transmission of the data although those communications systems operating in special modes using techniques such as frequency hopping or spread spectrum may require additional software at either the communication device, the last hop node or both such that all wireless communication devices within range may recognize a broadcast transmission.

However, broadcasting may be less than optimal. The transmission may not be adequately encrypted since all of the MCDs 140/141 must be able to receive the transmission and be able to identify the information contained therein. Further, the MCDs 140/141 associated with users that have no interest in the communication are burdened with the reception, identification and possible storage of data that is not desired. Essentially all unnecessary transmissions may be wasteful of scarce bandwidth resources.

According to exemplary embodiments, multicasting is a directly broadcast to a specified group of mobile communications devices, such as the MCDs 140/141, that have associated a unique IP address, such as the IP address 150/151, of the MCDs with an IP multicast group address 155, indicating that the user wants to receive what a data source 105 (e.g. an application provider) of the multicast is sending. According to exemplary embodiments, the data source 105 uses the group address 155 as the IP destination address in the data source's data packets. The MCDs 140/141 use this group address to inform the network 100 that the MCDs are interested in receiving packets sent to that group. For example, if some content is associated with a group address 239.X.Y.Z, the source 105 will send data packets addressed to 239.X.Y.Z. The MCDs 140/141 desiring that content will inform the network 100 that they are interested in receiving data packets sent to the group 239.X.Y.Z. The MCDs 140/141 thereby “join” the group address 239.X.Y.Z. The protocol used by receivers, such as the MCDs 140/141 to join a group may be the Internet Group Management Protocol (“IGMP”). IGMP informs the last hop node 130-132 in the network 100 about which of the addresses 150/151 are to be broadcasted to by the last hop nodes 130-132 as part of the multicast group. According to exemplary embodiments, if a last hop node, such as the last hop node 132, has no mobile communications device within transmission range, the last hop node 132 will not broadcast since it would be inefficient to broadcast where there is no receiver within the multicast group. If there is only a single, or a few, MCDs 140/141 within range, the last hop node 132 may either unicast to each MCD or broadcast once.

Further, the data objects that are associated together (say for a given application) may be provisioned using a unique source address. IGMP ver.3 and later versions may be used to request a group address, such as the group address 155, that is associated with a specific source, such as the data source 105. Individual data object transmissions, such as the data object 160, that are multicast from the single source 105 may be specifically subscribed to the exclusion of other data objects transmitted by using the same multicast group address 155. The data transmissions 160 (e.g. datagrams) from the single source 105 may, therefore, be generally excluded from reception with desired exceptions utilizing an “include” feature of IGMP. Conversely, the transmissions 160 may be generally included with certain undesired exceptions being excluded using an “exclude” feature. As such, the user would be able to receive the multicast transmission 160 from a specific first address 106 that is sent by a specific source, such as the source 105, to the multicast address 155. As a non-limiting example, a user may say that he wants his daily stock quote update (multicast address 239.X.Y.Z) to come from broker ABC (which is located at address 239.A.B.C) and be transmitted to his cell phone, such as the MCD 140, using a unique unicast address, such as the unique unicast address 150/151.

Alternatively, a similar functionality may be accomplished where the multicast capability is effectuated in the MCD 140/141 itself The data source 105 may transmit a data object, such as the data object 160. According to exemplary embodiments, the data message 160 with specific data content and with the destination address 155 in its packet header carries the data object 160 once to a number of the last hop broadcast nodes 130-132 (e.g. cell phone radio broadcast towers). The broadcast nodes 130-132 may then broadcast the data object 160 wherein the header of the message contains the group address 155. Any of the MCDs 140-141 within range that have associated themselves with the multicast group address 155 then receive and store the data object 160. Any of the MCDs 140/141 that do not recognize the multicast address 155 ignore the message containing the data object 160, in accordance with exemplary embodiments.

Where the multicast capability is alternatively instantiated in a network node 135-136 upstream of the MCD 140/141, the network node 135-136 may recognize which of the MCDs 140/141 were within range of last hop nodes 130-132 and are also associated with the multicast group address 155. The amount of network bandwidth used for a particular message, such as the data object 160, may therefore be a function of where in the network 100 the multicast association (e.g. mapping) occurs. In cases where there are no associated MCDs 140/141 in range, the last hop broadcast node 132 may not transmit the message 160 and may tell the last hop node's transmitting node 136 not to transmit. The message 160 may be transmitted up the network path until a node (i.e. node 135) has indication of an associated MCD within broadcast range of a last hop node, such as the last hope node 130, 131, 132, for example.

In the multicast service, the MCD 140/141 may be associated with the data 160 being transmitted. Such an association may be accomplished by associating the MCD 140/141 with an application 107 generating and using the data 160. As non-limiting examples the MCD 140/141 may be associated with the application 107 when the application is downloaded to the MCD. The association may be the result of an explicit contract (i.e. acceptance of terms and conditions), a machine-to-machine exchange of information or by arrangement between the application provider and the mobile communication network provider (i.e. associate all of my subscribers with the multicast address of my latest data upload for tonight).

With technological advances in and the cost reduction of memory components, memory capacity available in the network 100 and the MCD 140/141 is rapidly growing larger and may support a more robust use of data caching in order to better manage network bandwidth usage. As a non-limiting example, network data caching may be used to “time-shift” data broadcasts from periods of heavy bandwidth usage to periods of bandwidth overcapacity.

In accordance with various embodiments herein, data caches may be contained within the multicast service in a number of ways. As a non-limiting example, any communicated data 160 may be received and/or stored when the application 107 to which the data is directed is active on the MCD 140/141. If the application 107 executing on the MCD 140/141 is passive, there may be a separate subroutine or daemon with which to capture any incoming data messages/data objects 160 to the multicast group 155 to which the MCD has joined. Further, a standard cache may be created to capture incoming data, such as the data objects 160, whether the corresponding application 107 is active or not as part of the operating system of the MCD 140/141.

Further, network data caching may be combined with multicasting techniques in order to minimize the number of times that a particular data stream must be sent over the mobile communication network to each of a plurality of mobile communications devices. Network caching may occur at any node (130-136) within the network 100. Caching may occur as well at a central office server 120.

Rather than requiring multicasting at a specific time-of-day and day-of-week, multicasting may be made more dynamic by incorporating specific feed back from the MCD 140/141 such as geographic position, speed, direction of travel and other specific environmental characteristics. Environmental feedback may indicate a need for a more frequent transmission of the data objects 160 or a transmission of data for a different application that may be warranted under the circumstances. For example, a group of users with the MCD 140/141 traveling at 65 miles hour may be traveling in relatively close proximity by car where a mapping application may be useful. In such a case updated map data objects may be needed every 10 minutes instead of once a day in the case when each of the users is at home over the weekend in geographically dispersed locations, for example.

As a further example, the user may not be utilizing his mapping function at all. In that case the mobile communication system may be prompted to transmit the data objects 160 to prepare the mapping function for future use or may send data objects that may recommend that the user initialize the map function to the group of users. The data objects 160 may also initialize the map function automatically.

A dynamic multicasting capability may provide a group of users with bandwidth-on-demand, as a non-limiting example. While the users are stationary and/or the users' MCDs 140/141 are quiescent, the mobile communication network may transmit application data updates on a maintenance level that minimizes the use bandwidth during periods of peak bandwidth usage and/or maximizes bandwidth usage during periods of minimal system usage. Bandwidth availability may be automatically increased during periods of higher computing activity. If the mobile communication network is merely a service conduit, it may be the case that a third party application provider is providing the digital data content updates which may be cached at one or more locations at the application provider or within the mobile communication network

A dynamic multicasting capability may also allow the automatic customization of the data transmission. For example, the MCDs 140/141 traveling at an elevated rate of speed at a certain road location is more likely to be a unique user (or a small set of users) requiring a unicast or a very narrow multicast transmission as opposed to a MCD that is essentially stationary for hours (e.g. at a place of business or a sporting event) where the MCD may belong to one of hundreds of users that may need that same mapping data in preparation for leaving the sporting event. In the former case there may be only or a handful of travelers in the same vicinity that need the same map data object where in the later case the same map data object may be multicast once to several hundred users simultaneously.

Dynamic multicasting may also be used to preposition high-use or forecasted-use data objects within a group of MCDs during low bandwidth demand periods and/or in advance of the users need for such a data object. By pre-positioning the data objects 160, demand on bandwidth may be smoothed over time and service response time may therefore be enhanced. Pre-positioning allows real-time critical data transmissions to be received and combined with the pre-positioned data objects to provide the application service to the user.

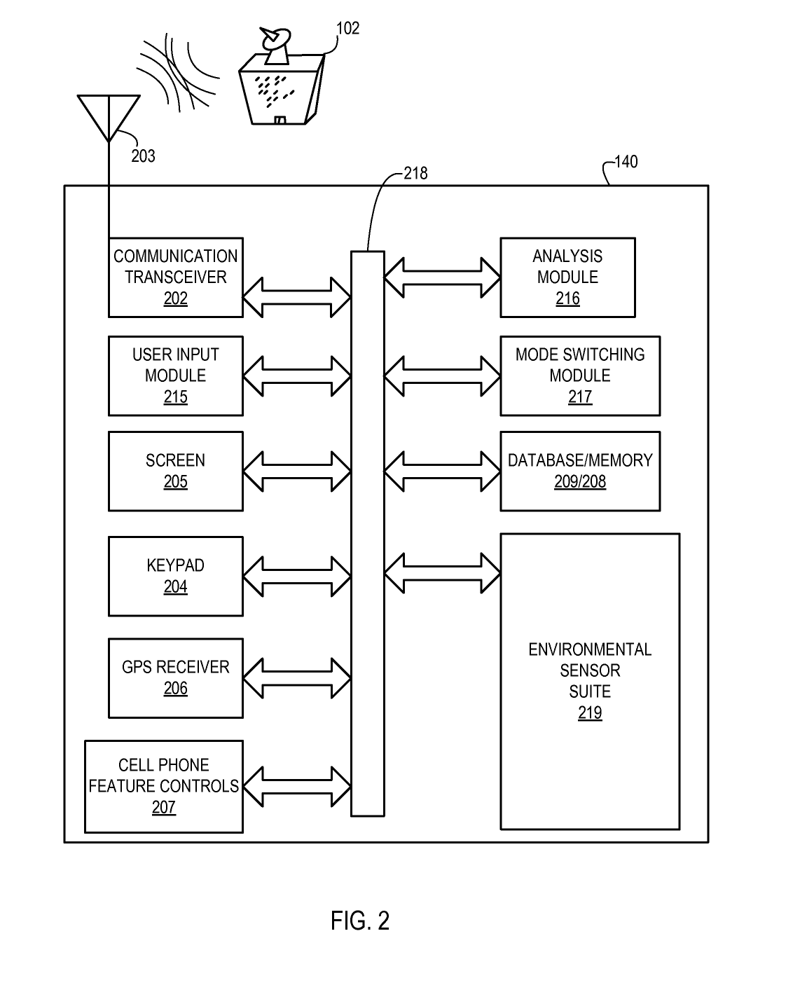

FIG. 2 is an exemplary depiction of the MCD 140 which may be in wireless communication with the network 100 via an antenna 203. The MCD 140 may comprise various components and modules in communication with each other through one or more buses 218. The MCD 140 may comprise one or more communication transceivers 202 for communication with wireless network 100 or a local wi-fi/BLUETOOTH® wireless LAN. Other modules of the MCD 140 may include a keypad 204 to receive user input and transfer that user input to a User Input Module 215 to manipulate the various features of the MCD 140. Components also include a screen 205 (including a touchscreen) as a user interface, cell phone feature controls 207, a GPS receiver 206, one or more memory units 208 and one or more databases/filesystems 209 contained therein. Other modules may also include an environmental sensor suite 219 containing one or more sensors used to inform the MCD 140 about the environmental conditions surrounding the user. The MCD 140 may further include an analysis module 216 and a mode switching module 217. The analysis module 216 analyzes the various inputs from the GPS receiver 206 and the sensor suite 219 using any number of signal processing techniques in order to cause a change in the operating mode of the MCD 140 based on the environmental conditions of the MCD 140, including the current geographical position.

Returning to the mapping application discussed above, data objects, such as the data object 160, comprising the actual map information corresponding to the local area surrounding a user may be uploaded during periods of slack bandwidth usage and/or periods when the user's MCD 140 is on and not being used. For example, small scale mapping objects 160 (covering large geographic areas) may be updated on a weekly or daily basis as long as the MCD 140 is not moving a significant geographical distance. A map of the county may be an example of a small scale mapping object 160. As long as the user is moving within a single county, for example, there would be no need to frequently update the small scale mapping object on the user's MCD 140/141. The update may be done during off peak periods. As the user moves about the county, the pre-positioned data objects may be recalled from the local memory 208 within the MCD cache 209 and combined with the MCD's current position, which may be multicasted in real time, to provide the user with a visual representation of his location. Receiving a set of current position coordinates is much faster and uses less bandwidth than uploading the map object 160 each time a new map object is required.

Prepositioning of data may be controlled by altering the source multicast address 106. Using a geographic example, the MCD 140/141 may move from an area covered by the last hop node 130 to an area covered by the last hop node 131, the handoff logic between nodes may result in the source multicast address 106 being changed to allow a different set of data objects/data stream 160 to be delivered to the same receiving multicast address 107 from a different source 105.

Pre-positioning of the data objects 160 may be useful in any number of mobile communication applications, such as the application 107. Other non-limiting examples may include stock quotes, sports results, weather reports, news reports, traffic reports, Airline schedules, internet browsing and the like. The data objects 160 may be any type of data objects and may also include audio files, graphics, text files, video clips and the like. As a non-limiting example, a noteworthy video clip may be having an extraordinarily high interest level. A news service provider would take advantage of dynamic multicasting to transmit the video clip to all of the provider's clients one time instead of each time a client requests the video clip. The video clip may be then cached at various places within the network 100, including on each of the subscribing MCD 140/141, such that the video clip would be available to any particular user who may want to view the clip in real time. By doing so, the user may experience a near instantaneous presentation, the news provider has an efficient execution of the news provider's service and the communication network provider does not suffer an excessive load on the network provider's wireless network bandwidth. Of course, if the user is not interested in the topic of the video clip, then the video clip may be erased by the user or erased on a time out basis in order to maintain sufficient memory space on the MCD 140/141 or other network cache.

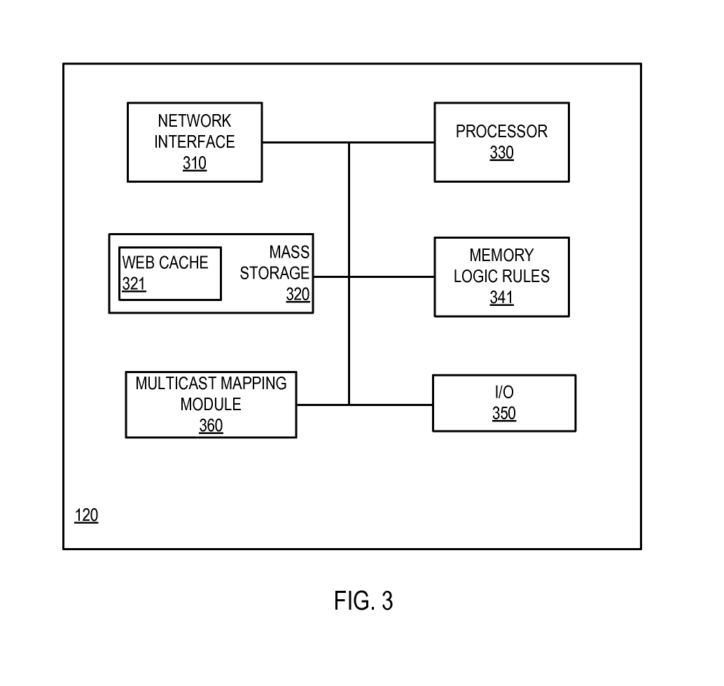

FIG. 3 is a simplified exemplary depiction of a mobile communication network server, such as the server 120, with a user interface 350. The server 120 may be located at or within a content provider service gateway 110, at the mobile communication service provider 102, at both or at another node within the network 100. As a non-limiting example, FIG. 3 depicts the mobile communication server 120 to be located at the mobile communication service provider 102. The server 120 may monitor and control data transmissions to the network 100 for data sources such as the data provider 105 as transmissions are received and forwarded via a network interface 3 10. Typically, a communications service provider caches incoming data for sundry technical and operational reasons. Such caches may reside in a server memory such as a mass storage device 320. Such caches may be data object caches 321. The mass storage device 320 may be any type of computer readable medium including volatile memory devices, non-volatile memory devices of which non-limiting examples may further include optical disks, magnetic disks, flash memory, random access memory, magnetic tape and any future modifications or advancements thereof.

While being cached, a processor 330 may monitor the caching process to determine what data or data objects 160 are transiting the central server 120 with a particularly high frequency. A high activity level may reflect high end user demand for those particular data objects. Non-limiting examples of such data objects 160 would include, video files, audio files, graphics, photographs, data structures and the like. After caching, the processor 330 may consult a set of logic rules 341 to determine which of the data objects 160 would be advantageous to multicast and to which multicast groups or subgroups. The server 120 may also include a separate multicast-to-user mapping module 360 where those user specific addresses that have been joined to one or more multicast addresses and/or source address may be stored in a look up table, database or some other advantageous data storage scheme.

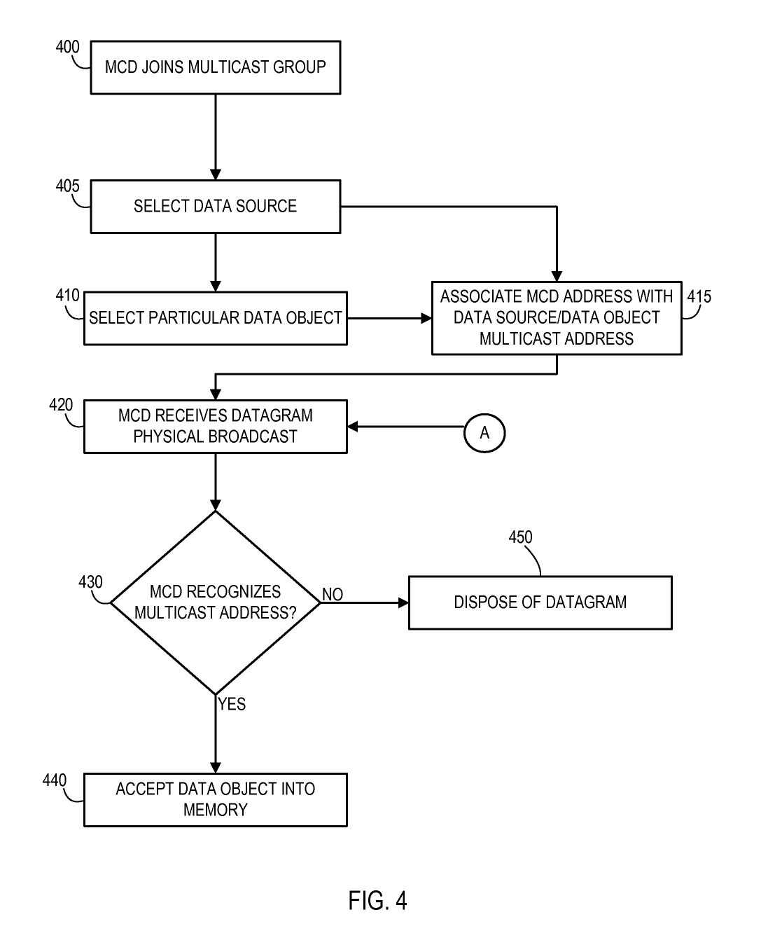

FIG. 4 is a flow chart illustrating an exemplary method for selecting and receiving a data object, such as the data object 160 multicast at a MCD, such as the MCD 140/141. At process 400, the MCD user selects a data content provider from which to receive certain data content. At process 405, the user joins a multicast group each member of which desires to receive the data content. The user may select a specific source, such as the source 105, at a specific source address, such as the address 106, from which to receive the data 160 by associating the unique MCD address 150/151 associated with the MCD 140/141 with the multicast address 155 (e.g. IGMP join). At process 410, the user may optionally select specific content by associating the unique MCD address 150/151 of the MCD 140/141 with a particular data object, such as the data object 160, to be sent by the data source 105. When the data source 105 multicasts the data object 160 to the MCD 140/141 (i.e. a multicast group), the data object is propagated through the IP or other protocol network 100 to each of the last hop nodes 130-132 in the network by processes that are well known in the art and is physically broadcast by each last hop node that knows that a member of the multicast group is active and in range. At process 420, the MCD 140/141 receives the physically broadcast data object 160 and examines the datagram for a multicast address that the MCD recognizes having been associated to the MCD in process 405/410. If the MCD 140/141 does not recognize the multicast address with which the datagram 160 is associated, the data object is discarded. If the MCD 140/141 does recognize the multicast address the datagram 160 is received into the memory 208 and processed in the normal course.

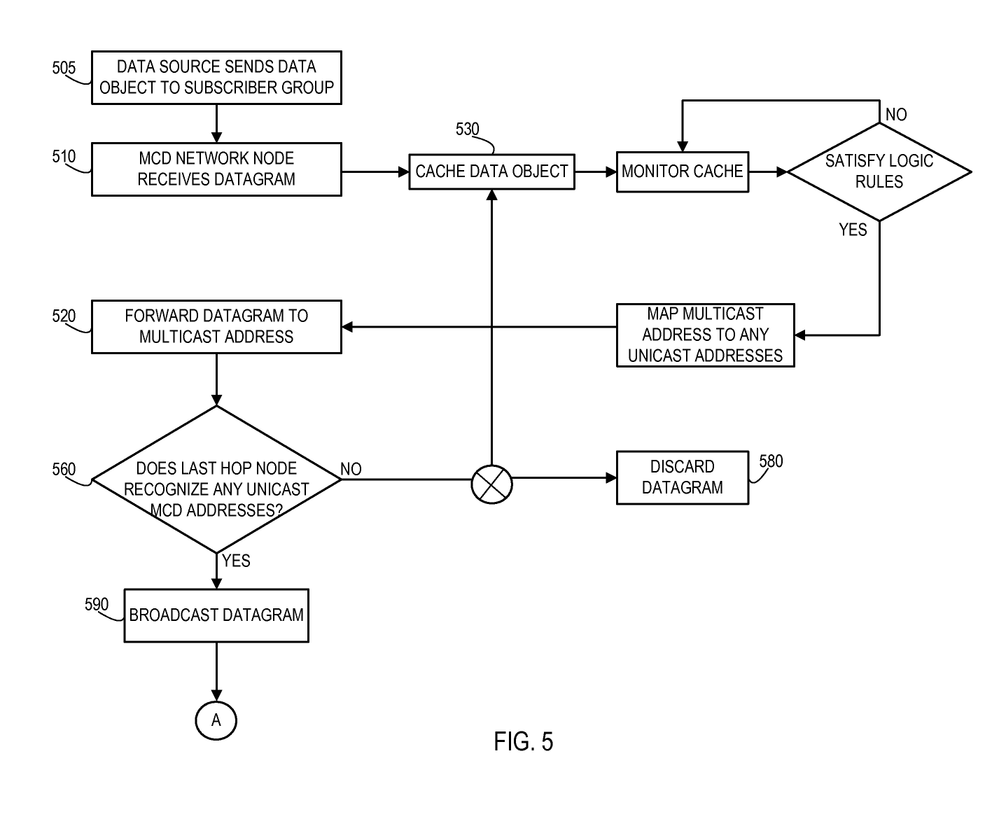

FIG. 5 is a flow diagram depicting an exemplary process performed by the source server 120 consistent with the embodiments described herein. It would be recognized by one skilled in the art that a similar process may be implemented at other nodes 130-136 within the network 100, particularly those that are capable of caching data objects, such as the data object 160, as the objects transit the network. At process 505 the data source 105 compiles the datagram 160 to be multicast to a group of the MCDs 140/141 that have joined a multicast group associated with the multicast address 155. The multicast address 155 is associated with the datagram 160 and is transmitted across the network 100. At process 5 10, the server 120 receives the datagram 160 addressed to the multicast address 155 and may cache the datagram in a cache, such as the cache 321, for optional retrieval at process 530. The cache 321 may be resident in the mass storage device 320 or elsewhere. At process 520, the server 120 forwards the datagram 160 to another of the nodes 130-136 in the network 100 for delivery to the multicast address 155 as is well known in the art. Optionally, at process 540 the cache 321 is monitored for the datagram 160 activity. The datagram 160 may be more popular that other datagrams and be experiencing a higher activity/transmission rate than others. As such, the logic memory rules 341 in the server 120 may cause the server 120 to anticipate user demand by one or more multicast groups as described more fully above. Upon the satisfaction of the logic rules 341 at process 550, the server 120 (or other node in network 100) may forward the particular data object 160 in anticipation of the object's demand by a particular multicast group associated with the multicast address 155 at process 520. If the logic rules 341 are not satisfied the monitoring process continues at process 540.

If the server 120 is also a last hop node, such as the last hop node 132 (i.e. it is associated with broadcast transmitter), a decision is made as to whether the server 120 detects an active member of the multicast group associated with the multicast address 155 within range at decision point 560. If not, then the datagram 160 may be discarded at process 580 or alternatively may be cached for later transmission at process 530. If a multicast group of the MCD 140/141 is available then the datagram 160 is broadcast to the MCD 140/141 where the datagram is received at process 420 of FIG. 4. As an alternative, at step 560 the network node (a last hop node or otherwise)130-136 may map the multicast address 155 to the member unicast addresses 150/151 such that upon forwarding to the member MCD's 140/141 the member MCDs may simply receive the datagram 160 directly without examination or unusual decryption in process 430 of FIG. 4.

Any of the instructions for carrying out the methods described herein may be read and/or executed from a computer readable medium. A computer readable medium may comprise any electronic memory device, memory disk or electronic signal capable of recording and/or conveying the instructions to a computing device. Non-limiting examples of a computer readable medium include volatile memory devices such as random access memory and computer processors and non-volatile memory devices such as optical disks, flash memory, magnetic disks and read only memory.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A network computing device in communication with a mobile communication device (“MCD”) comprising:
a network interface, the network interface allowing the network computing device to receive a data object sent by a data source destined for a multicast address;
a multicast mapping module, the multicast mapping module mapping the multicast address to one or more MCD unicast addresses which have been joined to the multicast address; and
a processor for:
receiving the data object; and
the one or more MCD unicast addresses prior to the data object being required from the network computing device by the MCD.

2. The network computing device of claim 1 further comprising a cache, the cache storing data objects until they are forwarded by the processor to the MCD according to a logic rule.

3. The network computing device of claim 2 wherein the logic rule causes the network computing device to multicast the data object in a manner minimizing peak network bandwidth usage.

4. The network computing device of claim 2 wherein the logic rule causes the network computing device to multicast the data object in a manner maximizing off peak network bandwidth usage.

5. The network computing device of claim 2 wherein the logic rule causes the network computing device to multicast the data object in response to an environmental input from the MCD.

6. The network computing device of claim 5 wherein the environmental input is a velocity of the MCD.

7. The network computing device of claim 5 wherein the environmental input is a geographic location of the MCD.

8. The network computing device of claim 1 wherein the network computing device is a server at a data content provider.

9. A method for pre-positioning a data object within a mobile communication device (“MCD”), comprising:
receiving a datagram containing at least a portion of a data object and a multicast address via a multicast prior to the MCD requesting the data object;
determining if a last hop node within the mobile communications network has an active MCD within broadcast range;
if the last hop node has an active MCD within broadcast range, then multicasting the datagram to the last hop node for physical broadcast; and
if the last hop node does not have an active MCD within broadcast range, then instructing the last hop node not to physically broadcast the datagram.

10. The method of claim 9, wherein the method includes mapping the multicast address to an associated unicast address.

11. The method of claim 9, wherein the method includes satisfying at least one of a set of logic rules concerning the delivery of the datagram to the MCD by a network node based at least on the multicast address.

12. The method of claim 9, wherein the method includes caching the datagram by the network node.

13. The method of claim 12, wherein the method includes monitoring the cache in comparison to a logic rule by the network node.

14. The method of claim 13, wherein the method includes forwarding the cached datagram from the network node to the multicast address when the logic rule is satisfied and in accordance with the logic rule.

15. A computer-readable medium containing a program within a logic device executing instructions to pre-position a data object within a mobile communication device (“MCD”), comprising:
receive a datagram containing a data object and a multicast address via a multicast prior to the MCD requesting the data object;
determine if a last hop node within the mobile communications network has an active MCD within broadcast range;
if the last hop node has an active MCD within broadcast range, then multicast the datagram to the last hop node for physical broadcast; and
if the last hop node does not have an active MCD within broadcast range, then instruct the last hop node not to physically broadcast the datagram.

16. The method of claim 15, wherein the instructions further include map the multicast address to an associated unicast address by the network node;

17. The method of claim 15, wherein the instructions further include satisfy at least one of a set of logic rules concerning the delivery of the data gram to the MCD by a network node based at least on the multicast address.

18. The method of claim 15, wherein the instructions further include cache the datagram by the network node.

19. The method of claim 18, wherein the instructions further include monitor the cache in comparison to a logic rule by the network node.

20. The method of claim 19, wherein the instruction further include forward the cached datagram from the network node to the multicast address when the logic rule is satisfied and in accordance with the logic rule.
